(19) United States
(12) Patent Application Publication
(10) Pub. No.: US 2025/0261024 A1
(43) Pub. Date: Aug. 14, 2025

(54) ENHANCEMENTS TO MEASUREMENT GAP CONFIGURATIONS FOR OVERHEAD REDUCTION

(71) Applicant: Apple Inc., Cupertino, CA (US)

(72) Inventors: Qiming Li, Beijing (CN); Dawei Zhang, Saratoga, CA (US); Jie Cui, San Jose, CA (US); Ping-Heng Kuo, London (GB); Weidong Yang, San Diego, CA (US); Yang Tang, San Jose, CA (US); Yuexia Song, Beijing (CN)

(21) Appl. No.: 19/053,095

(22) Filed: Feb. 13, 2025

Related U.S. Application Data
(60) Provisional application No. 63/553,074, filed on Feb. 13, 2024.

(51) Int. Cl. H04W 24/10; H04W 8/22; H04W 56/00

(52) U.S. Cl. CPC H04W 24/10; H04W 8/22; H04W 56/0015

(57) ABSTRACT

Disclosed are methods, systems, and computer-readable medium to perform operations including: receiving data specifying a pre-configured measurement gap, wherein the pre-configured measurement gap includes at least one of a per-band measurement gap or a per-carrier measurement gap, determining a status of the pre-configured measurement gap for a particular band or a particular carrier, the status including activated or deactivated, and performing measurements on one or more measurement objects on the particular band or the particular carrier based in part on the status of the pre-configured measurement gap.

### CROSS-REFERENCE TO RELATED APPLICATIONS

This application claims priority to and the benefit of U.S. Provisional Patent Application No. 63/553,074, filed Feb. 13, 2024, the entire contents of which is incorporated herein by reference.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### BRIEF DESCRIPTION OF THE FIGURES

FIG. 1 illustrates an example of pre-configured measurement gap (pre-MG) operation, according to some implementations.

FIG. 2 illustrates an example pre-MG operation, according to some implementations.

FIG. 3 illustrates a wireless network, according to some implementations.

FIG. 4 illustrates an example of per-carrier pre-MG operation, according to some implementations.

FIG. 5 illustrates an example of per-band pre-MG operation, according to some implementations.

FIGS. 6A-6B illustrate examples of pre-MG operation based on different UE capability indications, according to some implementations.

FIG. 7 illustrates a flowchart of an example method, according to some implementations.

FIG. 8 illustrates a flowchart of an example method, according to some implementations.

FIG. 9 illustrates an example user equipment (UE), according to some implementations.

FIG. 10 illustrates an example access node, according to some implementations.

### SUMMARY

Disclosed are techniques for enhancing pre-configured measurement gaps (pre-MGs) in order to reduce the overall measurement gap overhead without sacrificing performance.

In general, in a first aspect, a method includes: receiving data specifying a pre-configured measurement gap, where the pre-configured measurement gap includes at least one of a per-band measurement gap or a per-carrier measurement gap, determining a status of the pre-configured measurement gap for a particular band or a particular carrier, the status including activated or deactivated, and performing measurements on one or more measurement objects on the particular band or the particular carrier based in part on the status of the pre-configured measurement gap.

In a second aspect combinable with the first aspect, the pre-configured measurement gap includes the per-carrier measurement gap, the method further including: determining that the status of the pre-configured measurement gap is activated for the particular carrier based on at least one of the one or more measurement objects on the particular carrier being outside an active bandwidth part for the particular carrier.

In a third aspect combinable with the first or second aspects, the pre-configured measurement gap includes the per-carrier measurement gap, the method further including: determining that the status of the pre-configured measurement gap is deactivated based on the one or more measurement objects on the particular carrier being within an active bandwidth part for the particular carrier.

In a fourth aspect combinable with any of the first through third aspects, the pre-configured measurement gap includes the per-carrier measurement gap, and the status of the pre-configured measurement gap is activated for the particular carrier, the method further including: determining that a status of the pre-configured measurement gap is deactivated for a second carrier different from the particular carrier.

In a fifth aspect combinable with any of the first through fourth aspects, the pre-configured measurement gap includes the per-band measurement gap, the method further including: determining that the status of the pre-configured measurement gap is activated based on at least one of the one or more measurement objects on the particular band being outside a channel bandwidth of one or more serving cells within the band.

In a sixth aspect combinable with any of the first through fifth aspects, the pre-configured measurement gap includes the per-band measurement gap, the method further including: determining that the status of the pre-configured measurement gap is deactivated based on the one or more measurement objects on the particular band being within a channel bandwidth of one or more serving cells within the band.

In a seventh aspect combinable with any of the first through sixth aspects, the pre-configured measurement gap includes the per-band measurement gap, and the status of the pre-configured measurement gap is activated for the particular band, the method further including: determining that a status of the pre-configured measurement gap is deactivated for a second band different from the particular band.

In an eighth aspect combinable with any of the first through seventh aspects, the method includes instructing radio frequency (RF) circuitry to transmit capability information to a base station, the capability information including an indication of at least one of a per-band measurement gap capability or per-carrier measurement gap capability.

In a ninth aspect combinable with any of the first through eighth aspects, the capability information includes an indication of the per-carrier measurement gap capability, the per-carrier measurement gap capability indicating that the pre-configured measurement gap can be used to measure the one or more measurement objects outside an active bandwidth part of the particular carrier.

In a tenth aspect combinable with any of the first through ninth aspects, the capability information includes an indication of the per-band measurement gap capability, the per-band measurement gap capability indicating that the pre-configured measurement gap can be used to measure the one or more measurement objects outside a channel bandwidth of one or more serving cells in the particular band.\

In an eleventh aspect combinable with any of the first through tenth aspects, the capability information includes an indication of the per-band measurement gap capability, and an indication of the per-carrier measurement gap capability for each carrier within the particular band.

In a twelfth aspect combinable with any of the first through eleventh aspects, the method includes instructing radio frequency (RF) circuitry to transmit, to a base station, an indication of whether interruptions are needed when performing measurements using the pre-configured measurement gap.

In a thirteenth aspect combinable with any of the first through twelfth aspects, the method includes instructing radio frequency (RF) circuitry to transmit, to a base station, a report of the measurements on at least one of the one or more measurement objects.

In a fourteenth aspect combinable with any of the first through thirteenth aspects, the status of the pre-configured measurement gap is indicated by a base station.

In a fifteenth aspect combinable with any of the first through fourteenth aspects, the one or more measurement objects include one or more synchronization signal blocks (SSBs) on the particular band or the particular carrier.

In a sixteenth aspect combinable with any of the first through fifteenth aspects, the method is performed by a user equipment (UE).

In a seventeenth aspect combinable with any of the first through sixteenth aspects, the method is performed by one or more baseband processors.

In general, in an eighteenth aspect, one or more processors are configured to, when executing instructions stored in memory, perform the method of any of the first through fifteenth aspects.

In general, in a nineteenth aspect, a method includes: instructing radio frequency (RF) circuitry to transmit, to a user equipment (UE), data specifying a pre-configured measurement gap, where the pre-configured measurement gap includes at least one of a per-band measurement gap or a per-carrier measurement gap; instructing RF circuitry to transmit, to the UE, an indication of one or more measurement objects on a particular band or a particular carrier; and instructing RF circuitry to receive, from the UE, a report of one or more measurements on the one or more measurement objects on the particular band or the particular carrier.

In a twentieth aspect combinable with the nineteenth aspect, the method includes indicating, to the UE, a status of the pre-configured measurement gap for the particular band or the particular carrier, the status including activated or deactivated.

In a twenty-first aspect combinable with the nineteenth or twentieth aspects, the pre-configured measurement gap includes the per-carrier measurement gap, the method further including: determining that the pre-configured measurement gap is to be activated based on at least one of the one or more measurement objects on the particular carrier being outside an active bandwidth part for the particular carrier.

In a twenty-second aspect combinable with any of the nineteenth through twenty-first aspects, the pre-configured measurement gap includes the per-carrier measurement gap, the method further including: determining that the pre-configured measurement gap is to be deactivated based on the one or more measurement objects on the particular carrier being within an active bandwidth part for the particular carrier.

In a twenty-third aspect combinable with any of the nineteenth through twenty-second aspects, the pre-configured measurement includes the per-carrier measurement gap, and a status of the pre-configured measurement gap is to be activated for the particular carrier, the method further including: determining that a status of the pre-configured measurement gap is to be deactivated for a second carrier different from the particular carrier.

In a twenty-fourth aspect combinable with any of the nineteenth through twenty-third aspects, the pre-configured measurement gap includes the per-band measurement gap, the method further including: determining that the pre-configured measurement gap is to be activated based on at least one of the one or more measurement objects on the particular band being outside a channel bandwidth of one or more serving cells within the band.

In a twenty-fifth aspect combinable with any of the nineteenth through twenty-fourth aspects, the pre-configured measurement gap includes the per-band measurement gap, the method further including: determining that the pre-configured measurement gap is to be deactivated based on the one or more measurement objects on the particular band being within a channel bandwidth of one or more serving cells within the band.

In a twenty-sixth aspect combinable with any of the nineteenth through twenty-fifth aspects, the pre-configured measurement gap includes the per-band measurement gap, and a status of the pre-configured measurement gap is to be activated for the particular band, the method further including: determining that a status of the pre-configured measurement gap is to be deactivated for a second band different from the particular band.

In a twenty-seventh aspect combinable with any of the nineteenth through twenty-sixth aspects, the method further includes: instructing RF circuitry to receive, from the UE, capability information including an indication of at least one of a per-band measurement gap capability or per-carrier measurement gap capability; and based in part on the capability information, transmitting, to the UE, data specifying the pre-configured measurement gap.

In a twenty-eighth aspect combinable with any of the nineteenth through twenty-seventh aspects, the method further includes: instructing RF circuitry to receive, from the UE, an indication of whether interruptions are needed when performing measurements using the pre-configured measurement gap.

In a twenty-ninth aspect combinable with any of the nineteenth through twenty-eighth aspects, the method is performed by a base station.

In general, in a thirtieth aspect, a base station includes one or more processors configured to perform the method of any of the nineteenth through twenty-eighth aspects.

In general, in a thirty-first aspect, an apparatus includes one or more processors configured to perform the method of any of the first through twenty-eighth aspects.

In general, in a thirty-second aspect, one or more non-transitory computer storage mediums are encoded with instructions that, when executed by one or more processors, cause the one or processors to perform the method of any of the first through twenty-eighth aspects.

In general, in a thirty-third aspect, a system includes one or more processors and one or more storage devices storing instructions executable by the one or more processors to perform the method of any of the first through twenty-eighth aspects.

### DETAILED DESCRIPTION

Radio Resource Management (RRM) involves a set of functionalities and procedures to efficiently manage and optimize radio resources in a wireless communication network. RRM measurements (e.g., measurements of synchronization signal blocks (SSBs) or other downlink signals) play an important role in this process, as they provide the network with information about the radio environment that is needed to make informed decisions regarding resource allocation, handovers, and carrier aggregation (CA), among others. However, in some instances, conflicts may arise between RRM measurements and data transmission or reception. For example, a user equipment (UE) may not be able perform inter-frequency or certain intra-frequency RRM measurements while also transmitting or receiving data.

To ensure that a UE has an opportunity to perform RRM measurements, a network can configure the UE with one or more measurement gaps. In general, a measurement gap is a period of time when a UE temporarily stops transmitting and receiving data in order to perform measurements. Each measurement gap is configured through radio resource control (RRC) signaling that specifies parameters such as gap length and gap repetition period, among others defined, e.g., in 3GPP Technical Specification (TS) 38.133). Depending on UE capabilities, the network can configure the UE with separate measurement gaps for different frequency ranges, such as frequency range 1 (FR1) and frequency range 2 (FR2). Measurement gaps configured per frequency range are referred to as “per-FR” measurement gaps. Otherwise, if the UE is not capable of per-FR measurement gaps, the UE is configured with measurement gaps that spans multiple frequency ranges (e.g., both FR1 and FR2). These measurement gaps are referred to as “per-UE” measurement gaps. Once a measurement gap is configured, data transmission and reception can be interrupted at every gap occasion.

Although measurement gaps prevent conflicts between RRM measurements and data transmission/reception, they create overhead that can negatively impact system throughput. For instance, a typical measurement gap having a length of 6 ms and a repetition period of 40 ms can reduce throughput by about 15% while the measurement gap is active. This reduction can be particularly problematic for use cases that are very sensitive to system throughput, such as augmented reality (AR) and virtual reality (VR) use cases.

To help reduce measurement gap overhead, pre-configured measurement gaps (pre-MG) can be used. Similar to traditional measurement gaps, pre-MG are configured on a per-UE or per-FR basis via RRC signaling. However, unlike traditional measurement gaps that are activated and deactivated by RRC signaling, pre-MGs can be activated and deactivated much faster using downlink control information (DCI) and other mechanisms. The fundamental idea behind pre-MGs is that they are activated only when needed, such as when a UE's active bandwidth part (BWP) does not include the target SSB for RRM measurement. By activating the pre-MG only when it is needed (and deactivating it when it is not), the overall measurement gap overhead can be reduced.

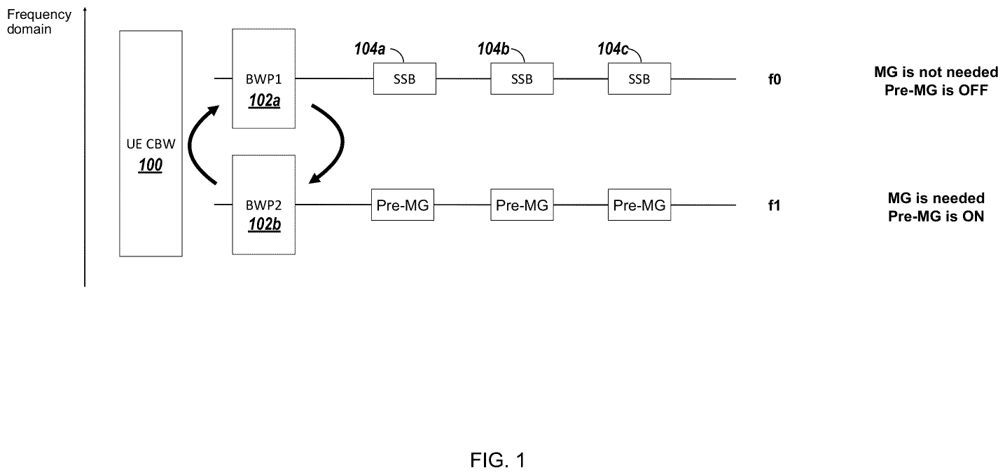

For instance, referring to FIG. 1, an example of pre-MG operation is shown. In this example, a UE is operating on a channel bandwidth (CBW) 100 that is split into two BWPs: BWP1 (102a) and BWP2 (102b). The target SSBs 104a, 104b, 104c for measurement are on frequency f0. If BWP1 (102a) is the active BWP, a measurement gap is not needed for the UE to measure SSBs 104a, 104b, 104c, as BWP1 includes frequency f0. As such, the pre-MG can be deactivated to avoid the measurement gap overhead. Such a deactivation can be achieved using a flag in the DCI that switches the active BWP to BWP1 (102a). On the other hand, if BWP2 (102b) is the active BWP, a measurement gap is needed for the UE to measure SSBs 104a, 104b, 104c, as BWP2 does not include frequency f0. Accordingly, the pre-MG can be activated to ensure the UE has an opportunity to measure SSBs 104a, 104b, 104c.

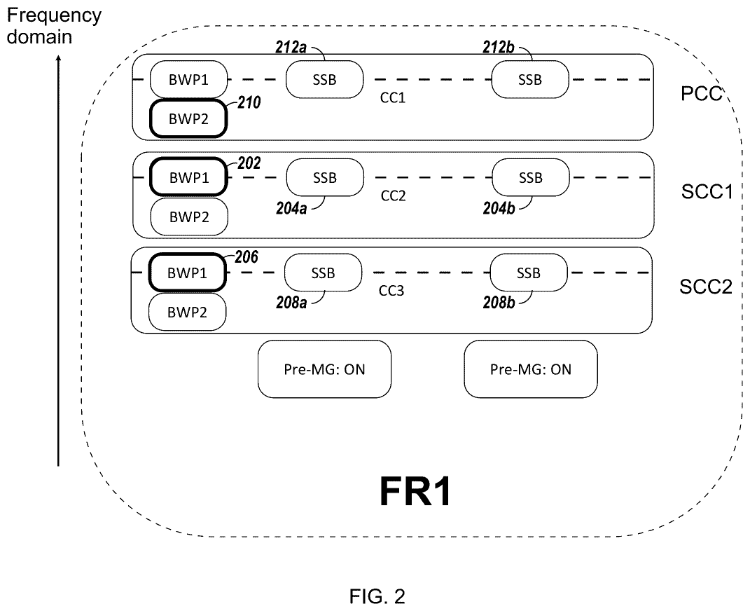

While the ability to quickly activate and deactivate pre-MGs can reduce some overhead, significant measurement gap overhead remains. For instance, referring to FIG. 2, another example of pre-MG operation is shown. In this example, a UE is being served by multiple serving cells each having multiple BWPs. If the active BWP of any of the serving cells does not contain the SSB to be measured, then the pre-MG is activated for all serving cells in FR1 (if it is a per-FR measurement gap), or for all serving cells in all frequency ranges (if it is a per-UE measurement gap). Here, active BWP1 (202) of component carrier 2 (CC2) contains SSBs 204a, 204b, and active BWP1 (206) of CC3 contains SSBs 208a, 208b. Thus, a measurement gap is not needed for the UE to perform the measurements on CC2 or CC3. However, active BWP2 (210) of CC1 does not contain SSBs 212a, 212b, so a measurement gap is needed. Thus, the pre-MG is activated for all serving cells in FR1 (or FR1 and FR2, if the pre-MG is configured per-UE). As a result, the UE cannot transmit or receive data during the pre-configured measurement gap on CC2 and CC3, even though a measurement gap is unnecessary on CC2 and CC3.

The present disclosure provides enhancements to pre-MGs that reduce overall measurement gap overhead without sacrificing UE mobility performance. In particular, new mechanisms of per-carrier and per-band pre-MGs are introduced. Also described are new UE capabilities to indicate to a network support for per-carrier and/or per-band pre-MGs, as well as capabilities to indicate whether interruption is needed when using a per-carrier and/or per-band pre-MG for RRM measurement. Enhancements to measurement latency scaling to support per-carrier and per-band pre-MGs are also described.

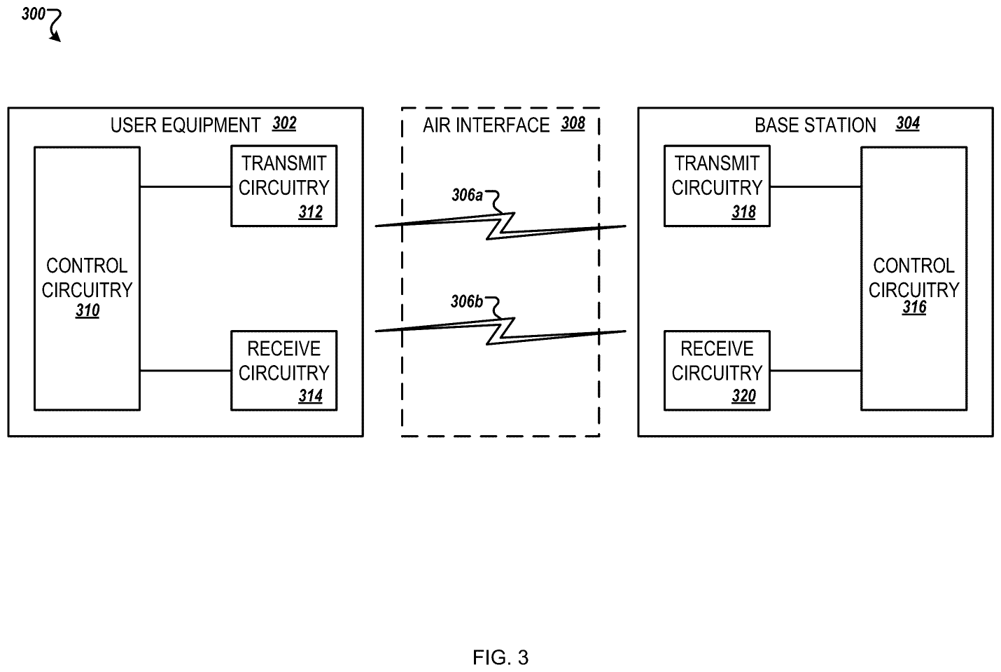

FIG. 3 illustrates a wireless network 300, according to some implementations. The wireless network 300 includes a UE 302 and a base station 304 connected via one or more channels 306A, 306B across an air interface 308. The UE 302 and base station 304 communicate using a system that supports controls for managing the access of the UE 302 to a network via the base station 304.

In some implementations, the wireless network 300 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 300 may be a E-UTRA (Evolved Universal Terrestrial Radio Access)-NR Dual Connectivity (EN-DC) network, or an NR-EUTRA Dual Connectivity (NE-DC) network. In some other implementations, the wireless network 300 may be a Standalone (SA) network that incorporates only 5G NR. Furthermore, other types of communication standards are possible, including future 3GPP systems (e.g., Sixth Generation (6G)), Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 300, the UE 302 and any other UE in the system may be, for example, any of laptop computers, smartphones, tablet computers, machine-type devices such as smart meters or specialized devices for healthcare, intelligent transportation systems, or any other wireless device. In network 300, the base station 304 provides the UE 302 network connectivity to a broader network (not shown). This UE 302 connectivity is provided via the air interface 308 in a base station service area provided by the base station 304. In some implementations, such a broader network may be a wide area network operated by a cellular network provider, or may be the Internet. Each base station service area associated with the base station 304 is supported by one or more antennas integrated with the base station 304. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 302 includes control circuitry 310 coupled with transmit circuitry 312 and receive circuitry 314. The transmit circuitry 312 and receive circuitry 314 may each be coupled with one or more antennas. The control circuitry 310 may include various combinations of application-specific circuitry and baseband circuitry. The transmit circuitry 312 and receive circuitry 314 may be adapted to transmit and receive data, respectively, and may include radio frequency (RF) circuitry and/or front-end module (FEM) circuitry.

In various implementations, aspects of the transmit circuitry 312, receive circuitry 314, and control circuitry 310 may be integrated in various ways to implement the operations described herein. The control circuitry 310 may be adapted or configured to perform various operations, such as those described elsewhere in this disclosure related to a UE. For instance, the control circuitry 310 can perform measurements on one or more measurement objects in accordance with the per-carrier and/or per-band pre-MGs described herein.

The transmit circuitry 312 can perform various operations described in this specification. For example, the transmit circuitry 312 can transmit the per-carrier and/or per-band pre-MG capability information and per-carrier and/or per-band pre-MG interruption information described herein. The transmit circuitry 312 can also transmit reports of the measurements performed using the per-carrier and/or per-band pre-MGs. Additionally, the transmit circuitry 312 may transmit using a plurality of multiplexed uplink physical channels. The plurality of uplink physical channels may be multiplexed, e.g., according to time division multiplexing (TDM) or frequency division multiplexing (FDM) along with carrier aggregation. The transmit circuitry 312 may be configured to receive block data from the control circuitry 310 for transmission across the air interface 308.

The receive circuitry 314 can perform various operations described in this specification. For instance, the receive circuitry 314 can receive the per-carrier and/or per-band pre-MG configuration(s), as well as the measurement objects to be measured according to the per-carrier and/or per-band pre-MGs. Additionally, the receive circuitry 314 may receive a plurality of multiplexed downlink physical channels from the air interface 308 and relay the physical channels to the control circuitry 310. The plurality of downlink physical channels may be multiplexed, e.g., according to TDM or FDM along with carrier aggregation. The transmit circuitry 312 and the receive circuitry 314 may transmit and receive, respectively, both control data and content data (e.g., messages, images, video, etc.) structured within data blocks that are carried by the physical channels.

FIG. 3 also illustrates the base station 304. In some implementations, the base station 304 may be a 5G radio access network (RAN), a next generation RAN, a E-UTRAN, a non-terrestrial cell, or a legacy RAN, such as a UTRAN. As used herein, the term “5G RAN” or the like may refer to the base station 304 that operates in an NR or 5G wireless network 300, and the term “E-UTRAN” or the like may refer to a base station 304 that operates in an LTE or 4G wireless network 300. The UE 302 utilizes connections (or channels) 306A, 306B, each of which includes a physical communications interface or layer.

The base station 304 circuitry may include control circuitry 316 coupled with transmit circuitry 318 and receive circuitry 320. The transmit circuitry 318 and receive circuitry 320 may each be coupled with one or more antennas that may be used to enable communications via the air interface 308. The transmit circuitry 318 and receive circuitry 320 may be adapted to transmit and receive data, respectively, to any UE connected to the base station 304. The receive circuitry 320 may receive a plurality of uplink physical channels from one or more UEs, including the UE 302.

In FIG. 3, the one or more channels 306A, 306B are illustrated as an air interface to enable communicative coupling, and can be consistent with cellular communications protocols, such as a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any other communications protocol(s). In implementations, the UE 302 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

In general, a UE capable of pre-MG can be configured with a pre-MG via RRC signaling. A measurement gap is configured as a pre-MG if preConfigInd is indicated by network in the configuration message of the measurement gap. In some example, a pre-MG is configured using a measurement gap pattern, such as described in 3GPP TS 38.133 v18.4.0, the entire content of which is hereby incorporated by reference. For example, any of the measurement gap patterns defined in 3GPP TS 38.133 Table 9.1.2-1 can be configured as pre-MG pattern:

TABLE 9.1.2-1
Gap Pattern Configurations

| | | Measurement |
|---|---|---|
| Gap | Measurement | Gap Repetition |
| Pattern | Gap Length | Period |
| Id | (MGL, ms) | (MGRP, ms) |
| 0 | 6 | 40 |
| 1 | 6 | 80 |
| 2 | 3 | 40 |
| 3 | 3 | 80 |
| 4 | 6 | 20 |
| 5 | 6 | 160 |
| 6 | 4 | 20 |
| 7 | 4 | 40 |
| 8 | 4 | 80 |
| 9 | 4 | 160 |
| 10 | 3 | 20 |
| 11 | 3 | 160 |
| 12 | 5.5 | 20 |
| 13 | 5.5 | 40 |
| 14 | 5.5 | 80 |
| 15 | 5.5 | 160 |
| 16 | 3.5 | 20 |
| 17 | 3.5 | 40 |
| 18 | 3.5 | 80 |
| 19 | 3.5 | 160 |
| 20 | 1.5 | 20 |
| 21 | 1.5 | 40 |
| 22 | 1.5 | 80 |
| 23 | 1.5 | 160 |
| 24 | 10 | 80 |
| 25 | 20 | 160 |

In some examples, the UE can determine the pre-MG status (e.g., activated or deactivated) based on an autonomous activation/deactivation mechanism, or based on a network-controlled activation/deactivation mechanism. For example, the UE can autonomously change the pre-MG status from activation to deactivation or vice versa based on any of the following triggering conditions: DCI, timer or RRC based active BWP switching, activation/deactivation of SCell(s), addition/removal of any measurement object(s), or addition/release/change of a SCell in carrier aggregation. The UE can also autonomously determine the pre-MG status based on all the concurrent triggering conditions occurring jointly.

The UE can autonomously determine the status of a pre-MG pattern as deactivated immediately after the configuration of the pre-MG pattern or when any of the triggering conditions above is satisfied provided that all the configured measurements (or all configured measurements in the same FR, band, or carrier) can be performed without measurement gaps. A measurement can be performed by the UE without measurement gaps if any of the following conditions is met: the UE is configured with SSB based intra-frequency measurements, and the conditions defined for SSB based intra-frequency measurement without gaps in clause 9.2.1 of 3GPP TS 38.133 are met, or the UE is configured with SSB based inter-frequency measurements, and the conditions defined for SSB based inter-frequency measurement without gaps in clause 9.3.1 of 3GPP TS 38.133 are met, or the UE is configured with CSI-RS based intra-frequency measurements.

The UE can autonomously determine the status of a pre-MG pattern as activated immediately after the configuration of the pre-MG pattern or when any of the triggering conditions above is satisfied provided that at least one of the configured measurements (or at least one of the configured measurements in the same FR, band, or carrier) cannot be performed without measurement gaps. A measurement cannot be performed by the UE without measurement gaps if any of the following conditions is met: the UE is configured with SSB based intra-frequency measurements, and the conditions defined for SSB based intra-frequency measurement without gaps in clause 9.2.1 of 3GPP TS 38.133 are not met, or the UE is configured with SSB based inter-frequency measurements, and the conditions defined for SSB based inter-frequency measurement without gaps in clause 9.3.1 of 3GPP TS 38.133 are not met, or the UE is configured with any of the following measurements: CSI-RS based inter-frequency measurements, or E-UTRA Inter-RAT measurements, or UTRA Inter-RAT measurements.

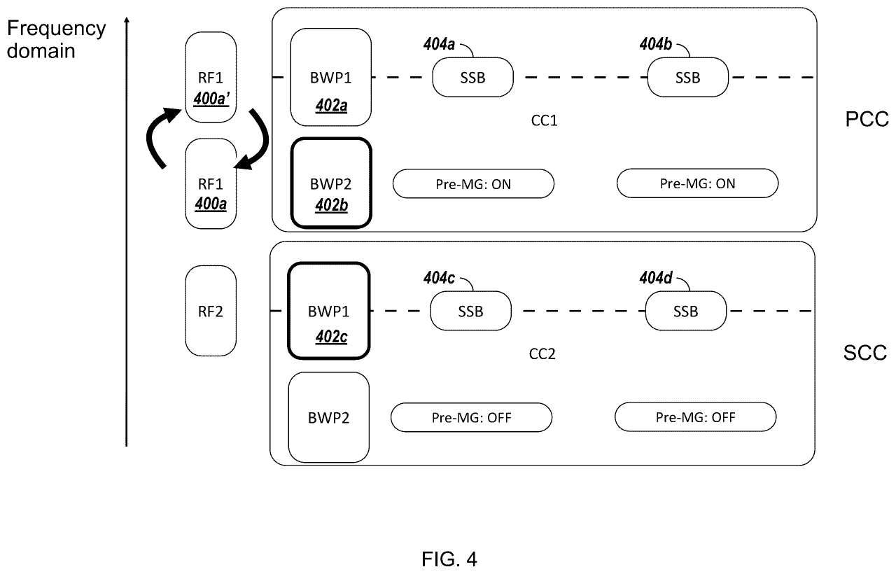

As discussed above, the present disclosure enhances pre-MGs to reduce overall measurement gap overhead without sacrificing UE mobility performance. In accordance with an aspect of the present disclosure, new mechanisms for per-band and per-carrier pre-MG are provided. Referring to FIG. 4, an example of per-carrier pre-MG operation is shown. This is an example of intra-frequency measurement, as all measurement objects (MOs) (e.g., SSBs or other downlink signals) are fully contained by the channel bandwidth (CBW) of the UE. In this example, the UE is using an RFI chain 400a for data transmission/reception on an active BWP2 (402b) of a primary component carrier (PCC). Because the active BWP2 (402b) does not fully contain the target SSBs 404a, 404b, a measurement gap is needed. Accordingly, the per-carrier pre-MG is activated for the PCC (CC1) to allow the UE to tune the RFI chain 400a (to 400a′) and perform measurements on the target SSBs 404a, 404b outside the active BWP2 (402b) (i.e., within the inactive BWP1 (402a)). In some examples, the UE may retune the RFI chain 400a for data transmission/reception on the active BWP2 (402b) in between the pre-MG occasions. Note that the per-carrier pre-MG is off for the secondary component carrier (SCC) (CC2), as the active BWP1 (402c) of the SCC fully contains the target SSBs 404c, 404d to be measured. As a result, data scheduling is allowed on SCC during the pre-MG occasions.

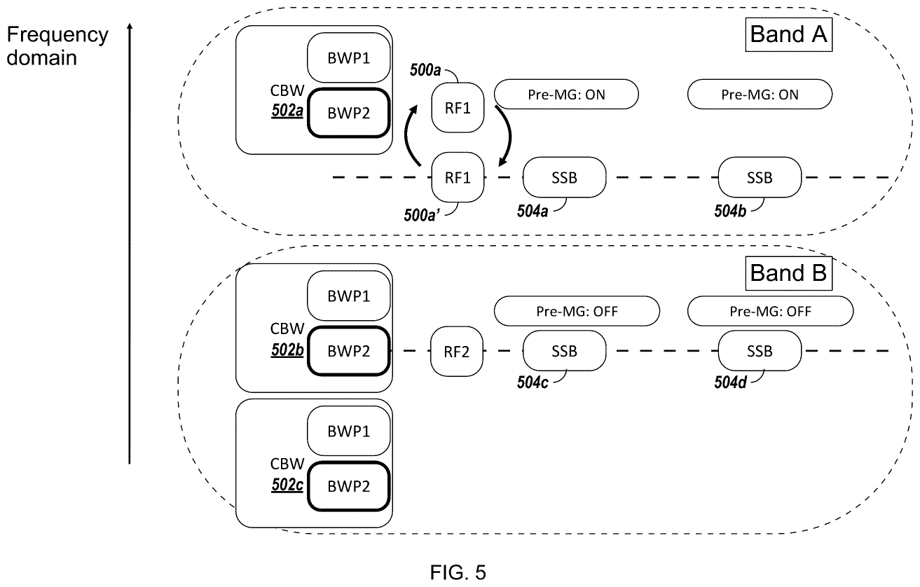

Referring to FIG. 5, an example of per-band pre-MG operation is shown. This is an example of inter-frequency measurement, as some MOs are not covered by the UE CBW, but are still within the same band. In this example, the UE is using an RFI chain 500a for data transmission/reception within the CBW 502a of a serving cell in Band A. Because the CBW 502a (and active BWP2) do not fully contain the target SSBs 504a, 504b, a measurement gap is needed. Accordingly, the per-band pre-MG is activated for Band A to allow the UE to tune the RFI chain 500a (to 500a′) and perform measurements outside the CBW 502a. In some examples, the UE may retune the RFI chain 500a′ (to 500a) for data transmission/reception on the CBW 502a of the serving cell in between the pre-MG occasions. Note that the per-band pre-MG is off for Band B, as the CBWs 502b, 502c of the serving cells in Band B fully contain the target SSBs 504c, 504d to be measured. Accordingly, data scheduling is allowed within Band B during the pre-MG occasions.

In accordance with an aspect of the present disclosure, new UE capabilities are provided to enable the UE to indicate to the network support for per-carrier and/or per-band pre-MGs. Such capabilities can be indicated using, for example, one or more parameters in a capability message to the network (e.g., to a base station). In some examples, a capability for per-carrier pre-MG is specified per carrier (e.g., per serving cell). Such a capability can take the form of, for example, perCCpreConfigInd ENUMERATED {true}, and can indicate whether the measurement gap is a per carrier pre-configured measurement gap. If true, the UE can use the pre-configured measurement gap to measure SSB(s) outside the UE active BWP but within the UE CBW of the serving cell. In some examples, report of perCCpreConfigInd is per cell or per carrier.

In some examples, a capability for per-carrier and/or per-band pre-MGs is specified per band (e.g., per frequency band). For each band, a UE can report two different indicators such as, for example, perCCpreConfigInd ENUMERATED {true} and perBandpreConfigInd ENUMERATED {true}. perCCpreConfigInd ENUMERATED {true} (or a variation thereof) can indicate whether the measurement gap is a per carrier pre-configured measurement gap. If true, the UE can use the pre-configured measurement gap to measure SSBs outside the UE active BWP but within the UE CBW of any serving cells in the same band. perBandpreConfigInd ENUMERATED {true} (or a variation thereof), can indicate whether the measurement gap is a per band pre-configured measurement gap. If true, the UE can use the pre-configured measurement gap to measure SSB which is outside the UE CBW of all serving cells in the same band.

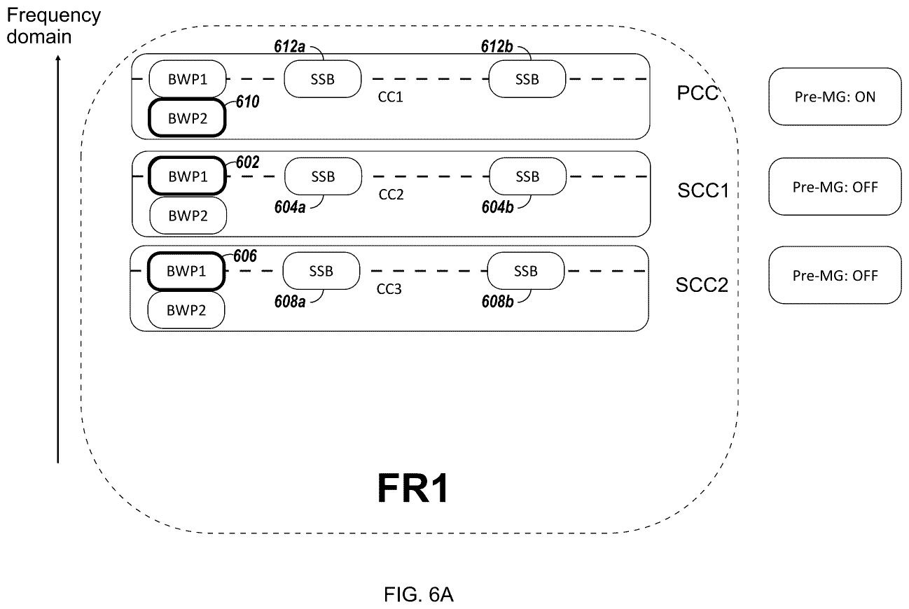

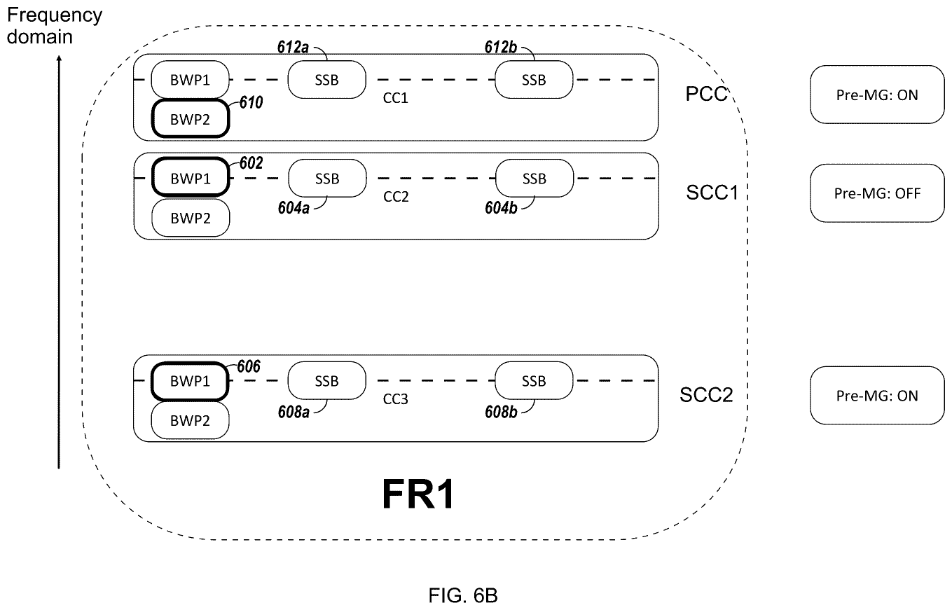

FIGS. 6A and 6B illustrate examples of pre-MG operation based on different UE capability indications. Referring to FIG. 6A, an example is shown in which a UE indicates support for per-carrier pre-MG for all serving cells. As discussed above, such an indication can be made by, for example, indicating a value of ‘true’ for perCCpreConfigInd for the serving cells associated with each of the PCC (CC1), SCC1 (CC2), and SCC2 (CC3). In this example, the active BWP1 (602) of CC2 contains SSBs 604a, 604b, and active BWP1 (606) of CC3 contains SSBs 608a, 608b. Thus, a measurement gap is not needed for the UE to perform the measurements on CC2 or CC3. However, active BWP2 (610) of CC1 does not contain SSBs 612a, 612b, so a measurement gap is needed. Since the UE has indicated support for per-carrier pre-MG for each of the serving cells, the pre-MG is activated for only PPC (CC1), and data scheduling is allowed on SCC1 (CC2) and SCC2 (CC3) during the pre-MG occasions. This is in contrast to FIG. 2, in which the pre-MG is activated for all serving cells in FR1 (or FR1 and FR2, if the pre-MG is configured per-UE) due to the lack of a per-carrier pre-MG.

Referring to FIG. 6B, an example is shown in which a UE indicates support for per-carrier pre-MG for some (but not all) serving cells. In particular, the UE indicates support for per-carrier pre-MG for the serving cells associated PCC and SCC1, but not SCC2. This may be due to, for example, the UE not being able to support simultaneous data transmission and RRM measurement on SCC2 due to a relatively large bandwidth of SCC2. Since the UE has indicated support for per-carrier pre-MG for each of PCC and SCC1, the pre-MG is activated for PPC (CC1), but remains deactivated for SSC1 (CC2). As a result, data scheduling is allowed on SCC1 (CC2) during the pre-MG occasions. However, since per-carrier pre-MG is not supported on SCC2 (CC3), the pre-MG is activated for SCC2 (CC3), and data scheduling is not allowed during the pre-MG occasions.

In accordance with an aspect of the present disclosure, new UE capabilities are provided to enable the UE to indicate to the network whether interruption is needed when using a per-carrier and/or per-band pre-MG for RRM measurement. Such capabilities can be indicated using, for example, one or more parameters in a capability message to the network (e.g., to a base station)., In general, interruption is not needed when different RF chains are well isolated such that tuning/retuning of one chain would be unlikely to cause interruption on other chain(s). Thus, by enabling a UE to indicate when interruptions are not needed, the time allocated for interruption (e.g., 0.5 ms in FR1, 0.25 ms in FR2) can be avoided, thereby increasing system throughput.

In some examples, the UE can indicate whether interruption is needed per-band combination. Such an indication can take the form of, for example, perBandpreConfigInterruption BOOLEAN, and can indicate whether interruption would be caused by using per carrier and/or per-band pre-configured measurement gap to measure SSB. The value ‘true’ indicates that the UE would cause interruption before and after the pre-configured measurement gap with status ON. The value ‘false’ indicates that the UE would not cause interruption before and after the pre-configured measurement gap with status ON.

If the UE indicates that an interruption is needed (e.g., by an indication of the value ‘true’), each interruption length shall not exceed 0.5 ms in FR1 and 0.25 ms in FR2. In some examples, when interruptions are needed, there are two interruptions (e.g., 2 slots) for each gap occasion (before and after the gap) to allow for RF tuning/retuning. In some examples, the interruption ratio shall not exceed the following:
up to [2.50%] probability of missed ACK/NACK when 80 ms≤Tcycle,i<160 ms, or
up to [1.25%] probability of missed ACK/NACK when 160 ms≤Tcycle,i<320 ms, or
up to [0.625%] probability of missed ACK/NACK when 320 ms≤Tcycle,i.
where Tcycle,i is the measurement cycle on a certain frequency layer i on which perBandpreConfigInterruption is set to ‘true.’ Note that no interruption is expected due to pre-configured measurement gap with status OFF.

In accordance with an aspect of the present disclosure, enhancements to measurement latency scaling to support per-carrier and per-band pre-MGs are described. In some examples, for MO(s) on carriers configured with per-carrier pre-MG (e.g., carriers for which perCCpreConfigInd ENUMERATED is set to ‘true’), measurement latency (or measurement delay) is scaled by a carrier-specific scaling factor (CSSF) within the measurement gaps. For instance, the measurement latency can be scaled by a CSSF within the measurement gaps as defined in 3GPP TS 38.133 v18.4.0, section 9.1.5.2. In some examples, for other MO(s) on carriers that are not configured with per-carrier pre-MG (e.g., carriers for which perCCpreConfigInd ENUMERATED is set to ‘false’), measurement latency (or measurement delay) is scaled by CSSF outside the measurement gaps. For instance, the measurement latency can be scaled by a CSSF outside the measurement gaps as defined in 3GPP TS 38.133 v18.4.0, section 9.1.5.1.

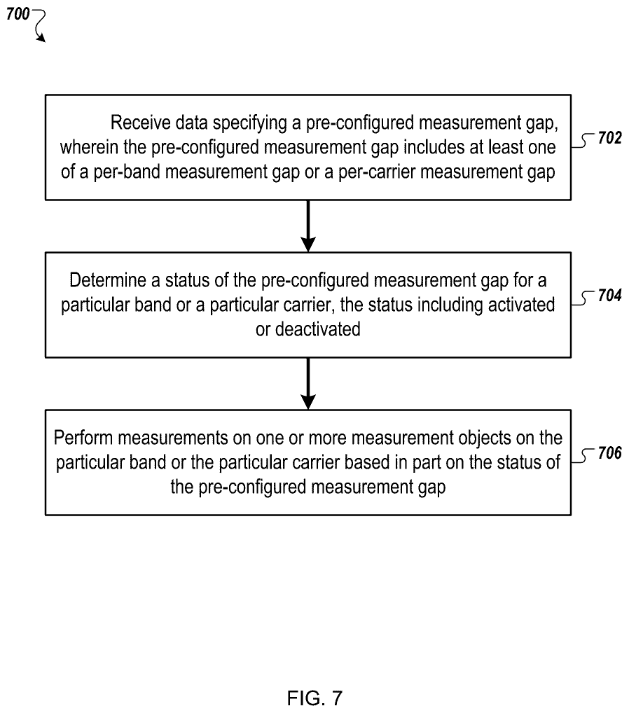

FIG. 7 illustrates a flowchart of an example method 700, according to some implementations. For clarity of presentation, the description that follows generally describes method 700 in the context of the other figures in this description. For example, method 700 can be performed by UE 302 of FIG. 3. It will be understood that method 700 can be performed, for example, by any suitable system, environment, software, hardware, or a combination of systems, environments, software, and hardware, as appropriate. In some implementations, various steps of method 700 can be run in parallel, in combination, in loops, or in any order.

Operations of the method 700 include receiving data specifying a pre-configured measurement gap, in which the pre-configured measurement gap includes at least one of a per-band measurement gap or a per-carrier measurement gap (702). In some examples, the pre-MG is configured by a base station via RRC signaling. Such signaling can include an indication (e.g., a flag) that the measurement gap is a pre-configured measurement gap, one or more parameters for the measurement gap (e.g., a gap length and/or period, which may be conveyed via an indication of a pre-defined gap pattern), and/or an indication of whether the pre-configured measurement gap is per-band and/or per-carrier.

A status of the pre-configured measurement gap is determined for a particular band or a particular carrier, the status being activated (e.g., pre-MG on) or deactivated (e.g., pre-MG off) (704). For instance, in some examples, the pre-configured measurement gap is a per-carrier measurement gap, and the method 700 includes determining that the status of the pre-configured measurement gap is activated for the particular carrier based on at least one of the one or more measurement objects on the particular carrier being outside an active bandwidth part for the particular carrier, or that the status of the pre-configured measurement gap is deactivated based on the one or more measurement objects on the particular carrier being within an active bandwidth part for the particular carrier. In some examples, the pre-configured measurement gap is a per-band measurement gap, and the method 700 includes determining that the status of the pre-configured measurement gap is activated based on at least one of the one or more measurement objects on the particular band being outside a channel bandwidth of one or more serving cells within the band, or that the status of the pre-configured measurement gap is deactivated based on the one or more measurement objects on the particular band being within a channel bandwidth of one or more serving cells within the band. In some examples, the status of the pre-configured measurement gap is indicated by a base station.

In some examples, the pre-configured measurement gap is a per-carrier measurement gap, and the status of the pre-configured measurement gap is activated for the particular carrier, and the method 700 includes determining that a status of the pre-configured measurement gap is deactivated for a second carrier different from the particular carrier. In some examples, the pre-configured measurement gap is a per-band measurement gap, and the status of the pre-configured measurement gap is activated for the particular band, and the method 700 includes determining that a status of the pre-configured measurement gap is deactivated for a second band different from the particular band.

Measurements are performed on one or more measurement objects on the particular band or the particular carrier based in part on the status of the pre-configured measurement gap (706). For example, if the pre-MG is active, the UE can perform measurements on the one or more measurement objects within one or more occasions of the pre-MG (which can also include one or more interruptions for RF tuning). In some examples, the one or more measurement objects include one or more synchronization signal blocks (SSBs) on the particular band or the particular carrier, although other downlink signals can be measured without departing from the scope of the present disclosure. In some examples, a report of the measurements on at least one of the one or more measurement objects is transmitted to the base station (e.g., for RRM).

In some examples, operations of the method 700 include transmitting capability information to a base station, the capability information including an indication of at least one of a per-band measurement gap capability or per-carrier measurement gap capability. In some examples, the capability information includes an indication of the per-carrier measurement gap capability, the per-carrier measurement gap capability indicating that the pre-configured measurement gap can be used to measure the one or more measurement objects outside an active bandwidth part of the particular carrier. In some examples, the capability information includes an indication of the per-band measurement gap capability, the per-band measurement gap capability indicating that the pre-configured measurement gap can be used to measure the one or more measurement objects outside a channel bandwidth of one or more serving cells in the particular band. In some examples, the capability information includes an indication of the per-band measurement gap capability, and an indication of the per-carrier measurement gap capability for each carrier within the particular band.

In some examples, the method 700 include transmitting, to a base station, an indication of whether interruptions are needed when performing measurements using the pre-configured measurement gap.

In some examples, operations of the method 700 include receiving data specifying a pre-configured measurement gap, wherein the pre-configured measurement gap is associated with at least one of a particular band or a particular carrier, determining a status of the pre-configured measurement gap, the status including activated or deactivated, and performing measurements on one or more measurement objects on the particular band or the particular carrier based in part on the status of the pre-configured measurement gap.

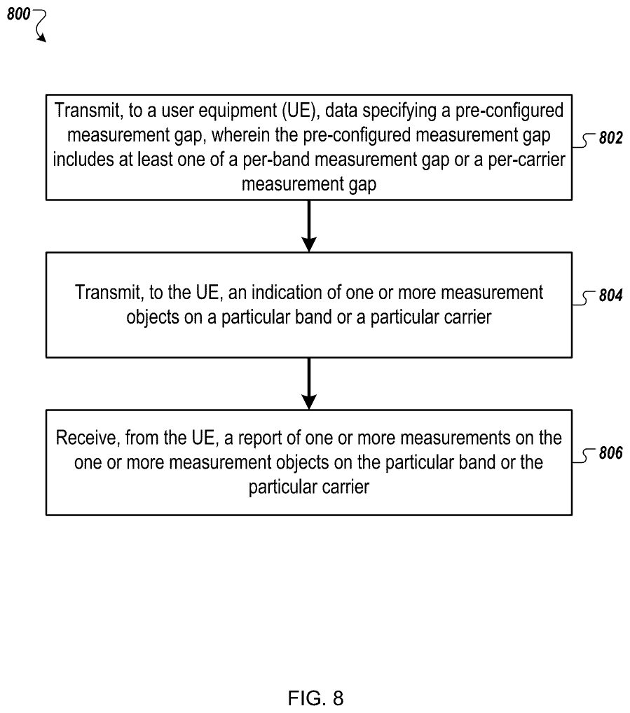

FIG. 8 illustrates a flowchart of an example method 800, according to some implementations. For clarity of presentation, the description that follows generally describes method 800 in the context of the other figures in this description. For example, method 800 can be performed by base station 304 of FIG. 3. It will be understood that method 800 can be performed, for example, by any suitable system, environment, software, hardware, or a combination of systems, environments, software, and hardware, as appropriate. In some implementations, various steps of method 800 can be run in parallel, in combination, in loops, or in any order.

Operations of the method 800 include transmitting, to a UE, data specifying a pre-configured measurement gap, the pre-configured measurement gap including at least one of a per-band measurement gap or a per-carrier measurement gap (802). In some examples, the data specifying the pre-MG is included in RRC signaling (e.g., an RRC message). Such signaling can include an indication (e.g., a flag) that the measurement gap is a pre-configured measurement gap, one or more parameters for the measurement gap (e.g., a gap length and/or period, which may be conveyed via an indication of a pre-defined gap pattern), and/or an indication of whether the pre-configured measurement gap is per-band and/or per-carrier.

An indication of one or more measurement objects on a particular band or a particular carrier are transmitted to the UE (804). In some examples, the one or more measurement objects include one or more synchronization signal blocks (SSBs) on the particular band or the particular carrier, although other downlink signals can be measured without departing from the scope of the present disclosure. A report of one or more measurements on the one or more measurement objects on the particular band or the particular carrier is received from the UE (806).

In some examples, operations of the method 800 include indicating, to the UE, a status of the pre-configured measurement gap for the particular band or the particular carrier, the status including activated or deactivated. For instance, in some examples, the pre-configured measurement gap is a per-carrier measurement gap, and operations of the method 800 include determining that the pre-configured measurement gap is to be activated based on at least one of the one or more measurement objects on the particular carrier being outside an active bandwidth part for the particular carrier, or that the pre-configured measurement gap is to be deactivated based on the one or more measurement objects on the particular carrier being within an active bandwidth part for the particular carrier. In some examples, the pre-configured measurement gap is a per-band measurement gap, and operations of the method 800 include determining that the pre-configured measurement gap is to be activated based on at least one of the one or more measurement objects on the particular band being outside a channel bandwidth of one or more serving cells within the band, or that the pre-configured measurement gap is to be deactivated based on the one or more measurement objects on the particular band being within a channel bandwidth of one or more serving cells within the band.

In some examples, the pre-configured measurement is per-carrier measurement gap, and a status of the pre-configured measurement gap is to be activated for the particular carrier, and operations of the method 800 include determining that a status of the pre-configured measurement gap is to be deactivated for a second carrier different from the particular carrier. In some examples, the pre-configured measurement gap is a per-band measurement gap, and a status of the pre-configured measurement gap is to be activated for the particular band, and operations of the method 800 include determining that a status of the pre-configured measurement gap is to be deactivated for a second band different from the particular band.

In some examples, operations of the method 800 include receiving, from the UE, capability information including an indication of at least one of a per-band measurement gap capability or per-carrier measurement gap capability, and based in part on the capability information, transmitting, to the UE, data specifying the pre-configured measurement gap. In some examples, operations of the method 800 include receiving, from the UE, an indication of whether interruptions are needed when performing measurements using the pre-configured measurement gap.

In some examples, operations of the method 800 include transmitting, to a UE, data specifying a pre-configured measurement gap, wherein the pre-configured measurement gap is associated with at least one of a particular band or a particular carrier, transmitting, to the UE, an indication of one or more measurement objects on the particular band or the particular carrier, and receiving, from the UE, a report of one or more measurements on the one or more measurement objects on the particular band or the particular carrier.

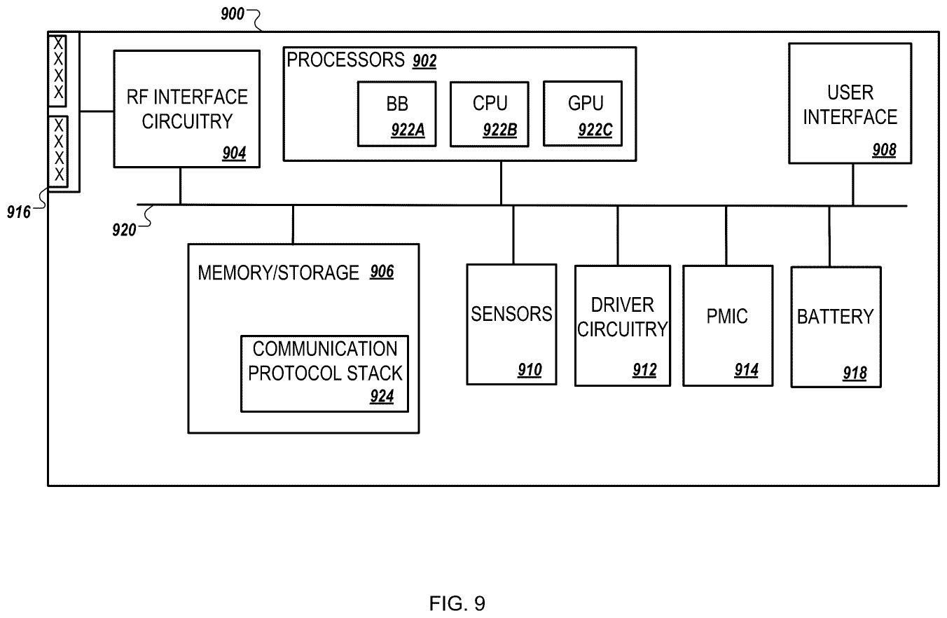

FIG. 9 illustrates an example UE 900, according to some implementations. The UE 900 may be similar to and substantially interchangeable with UE 302 of FIG. 3.

The UE 900 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 900 may include processors 902, RF interface circuitry 904, memory/storage 906, user interface 908, sensors 910, driver circuitry 912, power management integrated circuit (PMIC) 914, one or more antenna(s) 916, and battery 918. The components of the UE 900 may be implemented as integrated circuits (ICs), portions thereof, discrete electronic devices, or other modules, logic, hardware, software, firmware, or a combination thereof. The block diagram of FIG. 9 is intended to show a high-level view of some of the components of the UE 900. However, some of the components shown may be omitted, additional components may be present, and different arrangement of the components shown may occur in other implementations.

The components of the UE 900 may be coupled with various other components over one or more interconnects 920, which may represent any type of interface, input/output, bus (local, system, or expansion), transmission line, trace, optical connection, etc., that allows various circuit components (on common or different chips or chipsets) to interact with one another.

The processors 902 may include processor circuitry such as, for example, baseband processor circuitry (BB) 922A, central processor unit circuitry (CPU) 922B, and graphics processor unit circuitry (GPU) 922C. The processors 902 may include any type of circuitry or processor circuitry that executes or otherwise operates computer-executable instructions, such as program code, software modules, or functional processes from memory/storage 906 to cause the UE 900 to perform operations as described herein.

In some implementations, the baseband processor circuitry 922A may access a communication protocol stack 924 in the memory/storage 906 to communicate over a 3GPP compatible network. In general, the baseband processor circuitry 922A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 904. The baseband processor circuitry 922A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink. The baseband processor circuitry 922A may be adapted or configured to perform various operations, such as those described elsewhere in this disclosure related to a UE. For instance, the baseband processor circuitry 922A can perform measurements on one or more measurement objects in accordance with the per-carrier and/or per-band pre-MGs described herein.

The memory/storage 906 may include one or more non-transitory, computer-readable media that includes instructions (for example, communication protocol stack 924) that may be executed by one or more of the processors 902 to cause the UE 900 to perform various operations described herein. The memory/storage 906 include any type of volatile or non-volatile memory that may be distributed throughout the UE 900. In some implementations, some of the memory/storage 906 may be located on the processors 902 themselves (for example, L1 and L2 cache), while other memory/storage 906 is external to the processors 902 but accessible thereto via a memory interface. The memory/storage 906 may include any suitable volatile or non-volatile memory such as, but not limited to, dynamic random access memory (DRAM), static random access memory (SRAM), erasable programmable read only memory (EPROM), electrically crasable programmable read only memory (EEPROM), Flash memory, solid-state memory, or any other type of memory device technology.

The RF interface circuitry 904 may include transceiver circuitry and radio frequency front module (RFEM) that allows the UE 900 to communicate with other devices over a radio access network. The RF interface circuitry 904 may include various elements arranged in transmit or receive paths. These elements may include, for example, switches, mixers, amplifiers, filters, synthesizer circuitry, control circuitry, etc. In some examples, the RF interface circuitry 904 can transmit the per-carrier and/or per-band pre-MG capability information and per-carrier and/or per-band pre-MG interruption information described herein. The RF interface circuitry 904 can also transmit reports of the measurements performed using the per-carrier and/or per-band pre-MGs. The RF interface circuitry 904 can also receive the per-carrier and/or per-band pre-MG configuration(s), as well as the measurement objects to be measured according to the per-carrier and/or per-band pre-MGs.

In the receive path, the RFEM may receive a radiated signal from an air interface via antenna(s) 916 and proceed to filter and amplify (with a low-noise amplifier) the signal. The signal may be provided to a receiver of the transceiver that downconverts the RF signal into a baseband signal that is provided to the baseband processor of the processors 902.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 916. In various implementations, the RF interface circuitry 904 may be configured to transmit/receive signals in a manner compatible with NR access technologies.

The antenna(s) 916 may include one or more antenna elements to convert electrical signals into radio waves to travel through the air and to convert received radio waves into electrical signals. The antenna elements may be arranged into one or more antenna panels. The antenna(s) 916 may have antenna panels that are omnidirectional, directional, or a combination thereof to enable beamforming and multiple input, multiple output communications. The antenna(s) 916 may include microstrip antennas, printed antennas fabricated on the surface of one or more printed circuit boards, patch antennas, phased array antennas, etc. The antenna(s) 916 may have one or more panels designed for specific frequency bands including bands in FR1 or FR2.

The user interface 908 includes various input/output (I/O) devices designed to enable user interaction with the UE 900. The user interface 908 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 900.

The sensors 910 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 912 may include software and hardware elements that operate to control particular devices that are embedded in the UE 900, attached to the UE 900, or otherwise communicatively coupled with the UE 900. The driver circuitry 912 may include individual drivers allowing other components to interact with or control various input/output (I/O) devices that may be present within, or connected to, the UE 900. For example, driver circuitry 912 may include a display driver to control and allow access to a display device, a touchscreen driver to control and allow access to a touchscreen interface, sensor drivers to obtain sensor readings of sensors 910 and control and allow access to sensors 910, drivers to obtain actuator positions of electro-mechanic components or control and allow access to the electro-mechanic components, a camera driver to control and allow access to an embedded image capture device, audio drivers to control and allow access to one or more audio devices.

The PMIC 914 may manage power provided to various components of the UE 900. In particular, with respect to the processors 902, the PMIC 914 may control power-source selection, voltage scaling, battery charging, or DC-to-DC conversion.

In some implementations, the PMIC 914 may control, or otherwise be part of, various power saving mechanisms of the UE 900. A battery 918 may power the UE 900, although in some examples the UE 900 may be mounted deployed in a fixed location, and may have a power supply coupled to an electrical grid. The battery 918 may be a lithium ion battery, a metal-air battery, such as a zinc-air battery, an aluminum-air battery, a lithium-air battery, and the like. In some implementations, such as in vehicle-based applications, the battery 918 may be a typical lead-acid automotive battery.

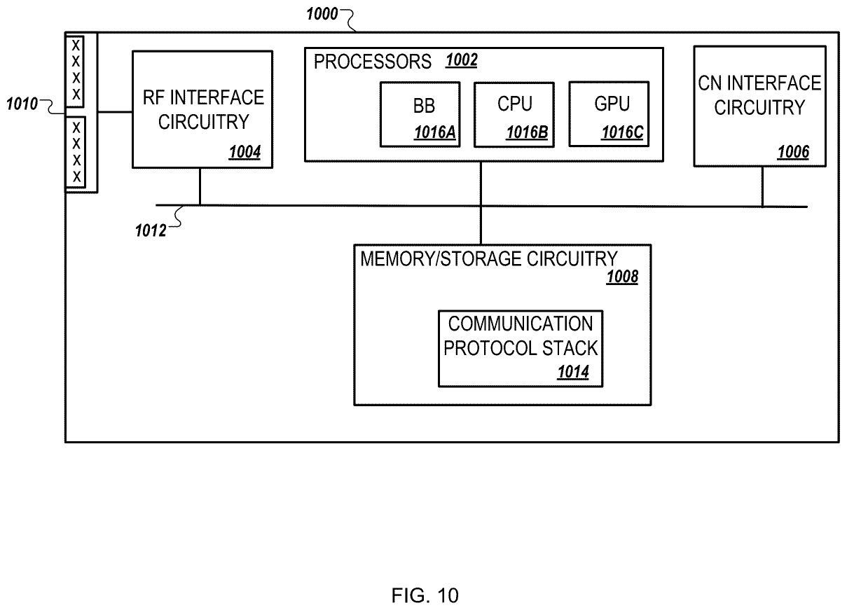

FIG. 10 illustrates an example access node 1000 (e.g., a base station or gNB), according to some implementations. The access node 1000 may be similar to and substantially interchangeable with base station 304. The access node 1000 may include processors 1002, RF interface circuitry 1004, core network (CN) interface circuitry 1006, memory/storage circuitry 1008, and one or more antenna(s) 1010.

The components of the access node 1000 may be coupled with various other components over one or more interconnects 1012. The processors 1002, RF interface circuitry 1004, memory/storage circuitry 1008 (including communication protocol stack 1014), antenna(s) 1010, and interconnects 1012 may be similar to like-named elements shown and described with respect to FIG. 9. For example, the processors 1002 may include processor circuitry such as, for example, baseband processor circuitry (BB) 1016A, central processor unit circuitry (CPU) 1016B, and graphics processor unit circuitry (GPU) 1016C.

The CN interface circuitry 1006 may provide connectivity to a core network, for example, a 5th Generation Core network (5GC) using a 5GC-compatible network interface protocol such as carrier Ethernet protocols, or some other suitable protocol. Network connectivity may be provided to/from the access node 1000 via a fiber optic or wireless backhaul. The CN interface circuitry 1006 may include one or more dedicated processors or FPGAs to communicate using one or more of the aforementioned protocols. In some implementations, the CN interface circuitry 1006 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1000 that operates in an NR or 5G system (for example, a gNB), and the term “E-UTRAN node” or the like may refer to an access node 1000 that operates in an LTE or 4G system (e.g., an eNB). According to various implementations, the access node 1000 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 1000 may be implemented as one or more software entities running on server computers as part of a virtual network, which may be referred to as a CRAN and/or a virtual baseband unit pool (vBBUP). In V2X scenarios, the access node 1000 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc., as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

We claim:

1. A method, comprising:
receiving data specifying a pre-configured measurement gap, wherein the pre-configured measurement gap comprises at least one of a per-band measurement gap or a per-carrier measurement gap;
determining a status of the pre-configured measurement gap for a particular band or a particular carrier, the status comprising activated or deactivated; and
performing measurements on one or more measurement objects on the particular band or the particular carrier based in part on the status of the pre-configured measurement gap.

2. The method of claim 1, wherein the pre-configured measurement gap comprises the per-carrier measurement gap, the method further comprising:
determining that the status of the pre-configured measurement gap is activated for the particular carrier based on at least one of the one or more measurement objects on the particular carrier being outside an active bandwidth part for the particular carrier.

3. The method of claim 1, wherein the pre-configured measurement gap comprises the per-carrier measurement gap, the method further comprising:
determining that the status of the pre-configured measurement gap is deactivated based on the one or more measurement objects on the particular carrier being within an active bandwidth part for the particular carrier.

4. The method of claim 1, wherein the pre-configured measurement gap comprises the per-carrier measurement gap, and wherein the status of the pre-configured measurement gap is activated for the particular carrier, the method further comprising:
determining that a status of the pre-configured measurement gap is deactivated for a second carrier different from the particular carrier.

5. The method of claim 1, wherein the pre-configured measurement gap comprises the per-band measurement gap, the method further comprising:
determining that the status of the pre-configured measurement gap is activated based on at least one of the one or more measurement objects on the particular band being outside a channel bandwidth of one or more serving cells within the band.

6. The method of claim 1, wherein the pre-configured measurement gap comprises the per-band measurement gap, the method further comprising:
determining that the status of the pre-configured measurement gap is deactivated based on the one or more measurement objects on the particular band being within a channel bandwidth of one or more serving cells within the band.

7. The method of claim 1, wherein the pre-configured measurement gap comprises the per-band measurement gap, and wherein the status of the pre-configured measurement gap is activated for the particular band, the method further comprising:
determining that a status of the pre-configured measurement gap is deactivated for a second band different from the particular band.

8. The method of claim 1, further comprising:
instructing radio frequency (RF) circuitry to transmit capability information to a base station, the capability information comprising an indication of at least one of a per-band measurement gap capability or per-carrier measurement gap capability.

9. The method of claim 8, wherein the capability information comprises an indication of the per-carrier measurement gap capability, the per-carrier measurement gap capability indicating that the pre-configured measurement gap can be used to measure the one or more measurement objects outside an active bandwidth part of the particular carrier.

10. The method of claim 8, wherein the capability information comprises an indication of the per-band measurement gap capability, the per-band measurement gap capability indicating that the pre-configured measurement gap can be used to measure the one or more measurement objects outside a channel bandwidth of one or more serving cells in the particular band.

11. The method of claim 8, wherein the capability information comprises an indication of the per-band measurement gap capability, and an indication of the per-carrier measurement gap capability for each carrier within the particular band.

12. The method of claim 1, further comprising:
instructing radio frequency (RF) circuitry to transmit, to a base station, an indication of whether interruptions are needed when performing measurements using the pre-configured measurement gap.

13. The method of claim 1, further comprising:
instructing radio frequency (RF) circuitry to transmit, to a base station, a report of the measurements on at least one of the one or more measurement objects.

14. The method of claim 1, wherein the status of the pre-configured measurement gap is indicated by a base station.

15. The method of claim 1, wherein the one or more measurement objects comprise one or more synchronization signal blocks (SSBs) on the particular band or the particular carrier.

16. The method of claim 1, wherein the method is performed by a user equipment (UE).

17. The method of claim 1, wherein the method is performed by one or more baseband processors.

18. One or more baseband processors configured to, when executing instructions stored in memory, perform operations comprising:
receiving data specifying a pre-configured measurement gap, wherein the pre-configured measurement gap comprises at least one of a per-band measurement gap or a per-carrier measurement gap;
determining a status of the pre-configured measurement gap for a particular band or a particular carrier, the status comprising activated or deactivated; and
performing measurements on one or more measurement objects on the particular band or the particular carrier based in part on the status of the pre-configured measurement gap.

19. A method, comprising:
instructing radio frequency (RF) circuitry to transmit, to a user equipment (UE), data specifying a pre-configured measurement gap, wherein the pre-configured measurement gap comprises at least one of a per-band measurement gap or a per-carrier measurement gap;
instructing RF circuitry to transmit, to the UE, an indication of one or more measurement objects on a particular band or a particular carrier; and
instructing RF circuitry to receive, from the UE, a report of one or more measurements on the one or more measurement objects on the particular band or the particular carrier.
